(19) United States
(12) Patent Application Publication
(10) Pub. No.: US 2012/0260891 A1
(43) Pub. Date: Oct. 18, 2012

(54) High Pressure Fuel Pump For An Internal Combustion Engine And Lubrication Strategy Therefor

(75) Inventors: Kraig M. Love, Dahinda, IL (US); Craig Phillip Hittle, Peoria, IL (US); Franklin J. Struwe, East Peoria, IL (US); Michael Patrick Harmon, Dunlap, IL (US)

(73) Assignee: CATERPILLAR INC., Peoria, IL (US)

(21) Appl. No.: 13/088,603

(22) Filed: Apr. 18, 2011

(51) Int. Cl. F02M 37/04

(52) U.S. Cl. 123/495

(57) ABSTRACT

An internal combustion engine includes an engine block defining at least one row of cylinders extending from a first end toward a second end. A flywheel housing is attached to the first end of the engine block and includes a pump engagement face having a first pump lubrication supply port opening therethrough. A high pressure fuel pump includes a flywheel housing engagement face having a second pump lubrication supply port opening therethrough. The pump engagement face of the flywheel housing abuts the flywheel housing engagement face of the high pressure fuel pump such that the first pump lubrication supply port and the second pump lubrication supply port are in fluid communication.

### TECHNICAL FIELD

The present disclosure relates generally to a lubrication strategy for a high pressure fuel pump, and more particularly to a strategy for sharing lubricating oil between a flywheel housing and the high pressure fuel pump.

### BACKGROUND

Common rail fuel systems typically include a fuel source and fuel delivery components for supplying fuel directly into cylinders of an internal combustion engine by way of a common rail. Fuel within the common rail may be pressurized to a relatively high pressure using one or more pumps, and may be delivered to fuel injectors through a plurality of individual fuel supply passages. For example, the fuel pumping arrangement may include a fuel transfer pump for drawing fuel from the fuel source and transferring it to a high pressure fuel pump. The high pressure fuel pump, which may increase the pressure of the fuel to a range of up to about 1,800 bar, supplies high pressure fuel to the common rail.

While the fuel transfer pump may be electrically operated or engine driven, the high pressure fuel pump is generally engine driven due to the high pressures that are required. Typically, the high pressure fuel pump is chain or belt driven by the crankshaft and positioned at the side of the engine. According to one example, U.S. Pat. No. 6,070,564 to Hiraoka et al. teaches an outboard motor having a crankshaft rotatable about a vertically disposed axis. Mounted above the flywheel and connected for rotation with the crankshaft is a first drive pulley which drives a toothed drive belt. The drive belt in turn drives another drive pulley that is connected to the input shaft of a drive transmission for the high pressure fuel pump. With the fuel pump positioned to the side of the engine, it may be difficult to access the pump and associated fuel lines for maintenance and repair.

The present disclosure is directed to one or more of the problems set forth above.

### SUMMARY OF THE DISCLOSURE

In one aspect, an internal combustion engine includes an engine block defining at least one row of cylinders extending from a first end toward a second end. A flywheel housing is attached to the first end of the engine block and includes a pump engagement face having a first pump lubrication supply port opening therethrough. A high pressure fuel pump includes a flywheel housing engagement face having a second pump lubrication supply port opening therethrough. The pump engagement face of the flywheel housing abuts the flywheel housing engagement face of the high pressure fuel pump such that the first pump lubrication supply port and the second pump lubrication supply port are in fluid communication.

In another aspect, a method of operating an internal combustion engine includes a step of circulating lubricating oil through an engine block. This step includes supplying the lubricating oil to a high pressure fuel pump along a pump lubrication pathway having an upstream segment defined, at least in part, by a flywheel housing, a first pump lubrication supply port and a second pump lubrication supply port. The method also includes a step of sealing against leakage between a pump engagement face of the flywheel housing and a flywheel housing engagement face of the high pressure fuel pump at the pump lubrication pathway using a sealing member.

In yet another aspect, a high pressure fuel pump for an internal combustion engine includes a fuel pump housing having a first end and a second end. A drive shaft is positioned within the fuel pump housing and extends from the first end to the second end. The high pressure fuel pump also includes a plurality of pistons configured to reciprocate within a fluid chamber upon rotation of the fuel pump drive shaft. A planar face defines at least a portion of the first end of the fuel pump housing and has a pump lubrication supply port and a pump lubrication drain port opening therethrough. The planar face also includes an annular groove positioned about the pump lubrication supply port.

### BRIEF DESCRIPTION OF THE DRAWINGS

FIG. 1 is a schematic view of an engine system, which includes a common rail fuel system, according to the present disclosure;

FIG. 2 is a perspective view of an internal combustion engine, with some components removed, according to one aspect of the present disclosure;

FIG. 3 is a perspective view similar to that of FIG. 2, with additional components removed;

FIG. 4 is a different perspective view of the internal combustion engine of FIGS. 2 and 3;

FIG. 5 is a cross sectional view of the high pressure fuel pump of FIGS. 2-4;

FIG. 6 is a schematic view of a lubrication system, according to another aspect of the present disclosure;

FIG. 7 is a perspective view of the flywheel housing of FIG. 2, according to another aspect of the present disclosure; and

FIG. 8 is a perspective view of the high pressure fuel pump of FIGS. 2-5, according to another aspect of the present disclosure.

### DETAILED DESCRIPTION

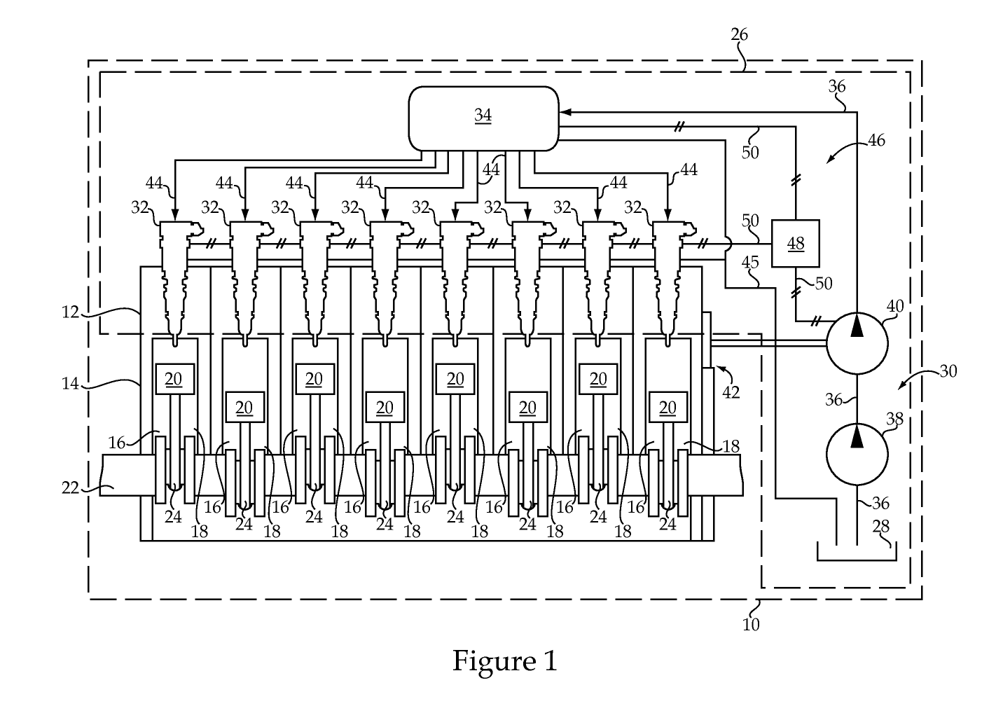

Referring to the schematic of FIG. 1, an engine system 10 may generally include an internal combustion engine 12, such as a compression ignition engine. The internal combustion engine 12 may include an engine block 14 that defines a plurality of cylinders 16, the number of which may vary, each of which forms a combustion chamber 18. A piston 20 is slidable within each cylinder 16 to compress air within the respective combustion chamber 18. The internal combustion engine 12 also includes a crankshaft 22 that is rotatably disposed within the engine block 14. A connecting rod 24 may connect each piston 20 with the crankshaft 22 such that sliding motion of the pistons 20 within each respective cylinder 16 results in a rotation of the crankshaft 22. Similarly, rotation of the crankshaft 22 may result in linear sliding motion of the pistons 20.

The engine system 10 may also include a fuel system 26, for supplying fuel into each of the combustion chambers 18 during operation of the internal combustion engine 12. The fuel system 26, also referred to as a common rail fuel system, may include a fuel tank 28 configured to hold a supply of fuel, and a fuel pumping arrangement 30 configured to pressurize the fuel and direct the pressurized fuel to a plurality of fuel injectors 32 by way of a common rail 34. The fuel pumping arrangement 30 may include one or more pumping devices that function to increase the pressure of the fuel and direct one or more pressurized streams of fuel to the common rail 34 using fuel lines 36. For example, the fuel pumping arrangement 30 may include a fuel transfer pump 38, or low pressure fuel pump, that draws fuel from the fuel tank 28 and pumps pressurized fuel to a high pressure fuel pump 40. The high pressure fuel pump 40 increases the pressure of the fuel and pumps the high pressure fuel to the common rail 34. One or both of the fuel transfer pump 38 and the high pressure fuel pump 40 may be operably connected to the internal combustion engine 12 and driven by the crankshaft 22. For example, the high pressure fuel pump 40 may be connected to the crankshaft 22 through a gear train 42, a specific example of which will be discussed later in greater detail.

The fuel injectors 32 may be disposed within a portion of the cylinder block/head 14, as shown, and may be connected to the common rail 34 via a plurality of individual branch passages 44. Each fuel injector 32 may be operable to inject an amount of pressurized fuel into an associated combustion chamber 18 at predetermined timings, fuel pressures, and fuel flow rates. The timing of fuel injection into the combustion chambers 18 may be synchronized with the motion of the pistons 20. For example, fuel may be injected as piston 20 nears a top-dead-center position in a compression stroke to allow for compression-ignited combustion of the injected fuel. Alternatively, fuel may be injected as piston 20 begins the compression stroke heading towards a top-dead-center position for homogenous charge compression ignition operation. As shown, fuel injectors 32 may also be fluidly connected to fuel tank 28 via one or more drain lines 45.

A control system 46 may be associated with fuel system 26 and/or engine system 10 to monitor and control the operations of the fuel pumping arrangement 30, fuel injectors 32, and various other components of the fuel system 26. In particular, and according to the exemplary embodiment, the control system 46 may include an electronic controller 48 in communication with the high pressure fuel pump 40 and each of the fuel injectors 32 via communication lines 50. For example, the electronic controller 48 may be configured to control pressurization rates and injection, thus improving performance and control of the internal combustion engine 12. Although a particular embodiment is shown, it should be appreciated that the control system 46 may be configured to provide any desired level of control, and may include any number of components and/or devices, such as, for example, sensors, useful in providing the desired control.

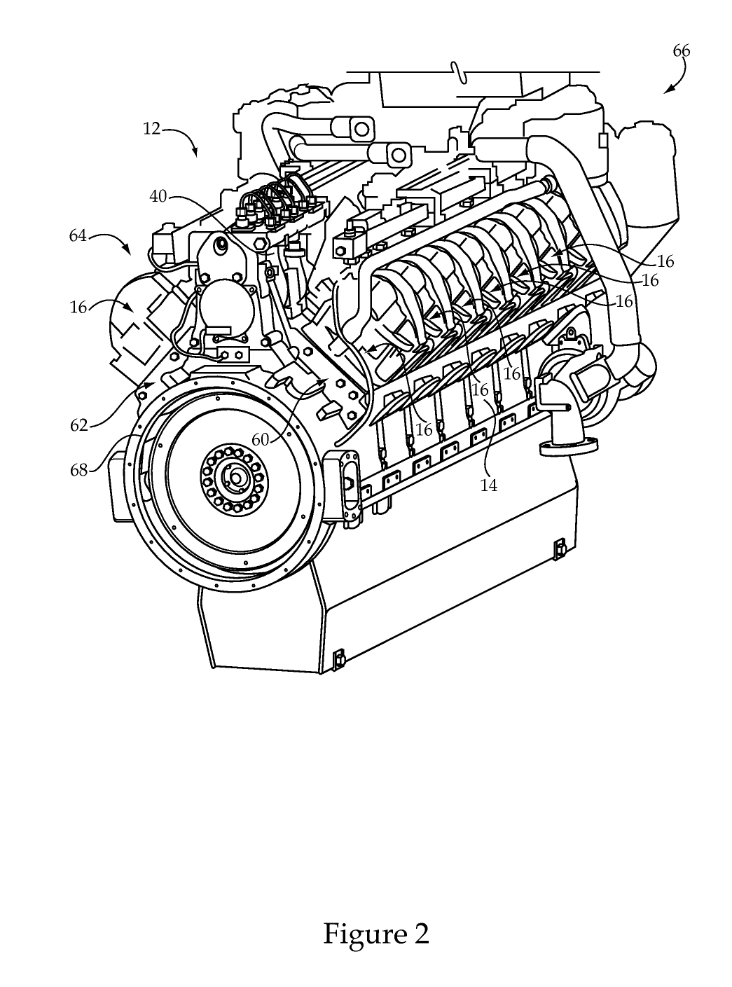

Turning now to FIG. 2, an exemplary embodiment of the internal combustion engine 12 according to the present disclosure is shown. The internal combustion engine 12, having components removed, includes the engine block 14 defining a first row 60 and a second row 62 of cylinders 16. The rows 60 and 62 of cylinders 16 extend from a first end 64 of the engine block 14 toward a second end 66. Although a specific number of cylinders 16 are shown arranged in a V orientation, it should be appreciated that any number of cylinders may be provided in one or two rows and may have various angles of orientation. Such design specifications may vary depending on a particular application. It should be appreciated that such engines may be used in on-highway or off-highway machine applications, marine applications, or power generation applications.

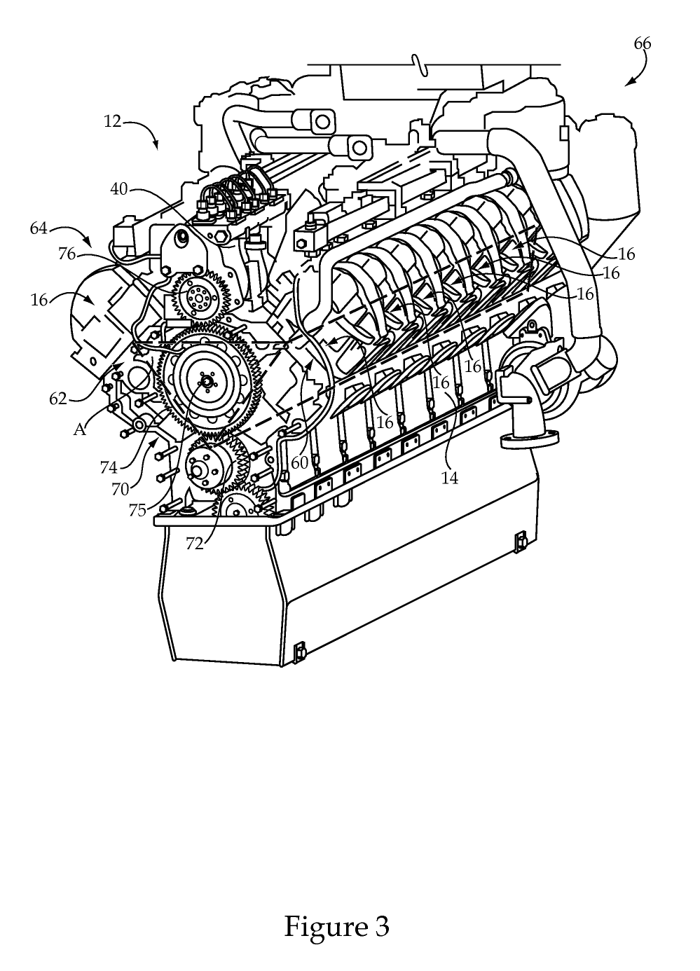

A flywheel housing 68 is attached to the first end 64 of the engine block 14 using known attachment means and houses or supports, at least partially, a gear train 70, shown in FIG. 3 (with the flywheel housing 68 removed). The gear train 70 may include a crank gear 72, which may be driven by the crankshaft 22 of FIG. 1, meshed to drive rotation of a cam gear 74. The power transmitted from the crank gear 72 to the cam gear 74 may be transferred to drive rotation of a camshaft 75 and a number of powered gears, including a fuel pump gear 76. The fuel pump gear 76 may, in turn, drive the high pressure fuel pump 40, referenced above with respect to FIG. 1. As should be appreciated, the gear train 70 may include any number of gears, including idler gears, that drive rotation of various engine components and accessories, such as, for example, hydraulic and lubricating oil pumps.

As shown, the high pressure fuel pump 40 is mounted to the flywheel housing 68 at a position over and above the engine block 14. In addition, the high pressure pump 40 is positioned over and above a V shaped area “A” defined by the first and second row of cylinders 60 and 62. As should be appreciated, the term “above,” as used herein, means that one component is positioned at a higher location relative to another component. Specifically, the high pressure fuel pump 40 is situated above or is elevated with respect to the engine block 14 and the V shaped area “A” defined by the cylinders 16 relative to a gravitational pull. In addition, the term “over,” as used herein, means that one component has a position vertically above, or on top of, another component. Specifically, the high pressure fuel pump 40 is situated over the engine block 14 and the V shaped area “A”, such that the high pressure fuel pump 40 is in vertical alignment with the engine block 14 and the V shaped area “A.”

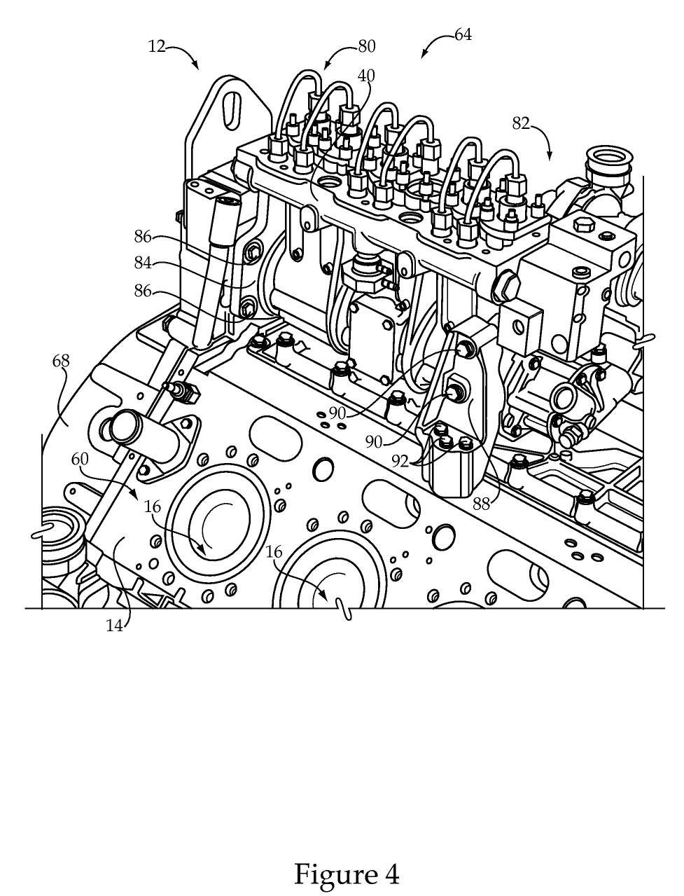

As shown in FIG. 4, the high pressure fuel pump 40 may have a first end 80 attached to the flywheel housing 68 and a second end 82 attached to the engine block 14. Specifically, flanges 84 extending from either side of the first end 80 of the high pressure fuel pump 40 may be attached, using bolts 86 or other fastening devices, to the flywheel housing 68. Although only one side of the high pressure fuel pump 40 is shown in the perspective view of FIG. 4, it should be appreciated that the high pressure fuel pump 40 may include a similar flange located on the other side of the fuel pump 40 for attachment in a similar fashion to the flywheel housing 68.

The second end 82 of the high pressure fuel pump 40 may be attached to the engine block 14 using a bracket 88, or other similar component. The bracket 88 may be attached to the high pressure fuel pump 40 using bolts 90 and to the engine block 14 using bolts 92. Although bolted attachments are shown, it should be appreciated that the components described herein may be attached using any known fastening means incorporating any known fastening devices. Further, “attached,” as used herein, is used generally to describe components that are affixed, joined, connected, or otherwise held in contact.

By attaching the high pressure fuel pump 40 to the engine block 14, oscillation of the high pressure fuel pump 40 due to operation of the internal combustion engine 12 may be reduced. As should be appreciated, if the internal combustion engine 12 causes the high pressure fuel pump 40 to vibrate at its resonance frequency, such oscillation may result in damage to one or more components of the internal combustion engine 40. The bracket 88, also referred to as a vibration transfer reduction member, may prevent the high pressure fuel pump 40 from being cantilevered from the flywheel housing 68 and may reduce stress and damage that may be caused by vibrations.

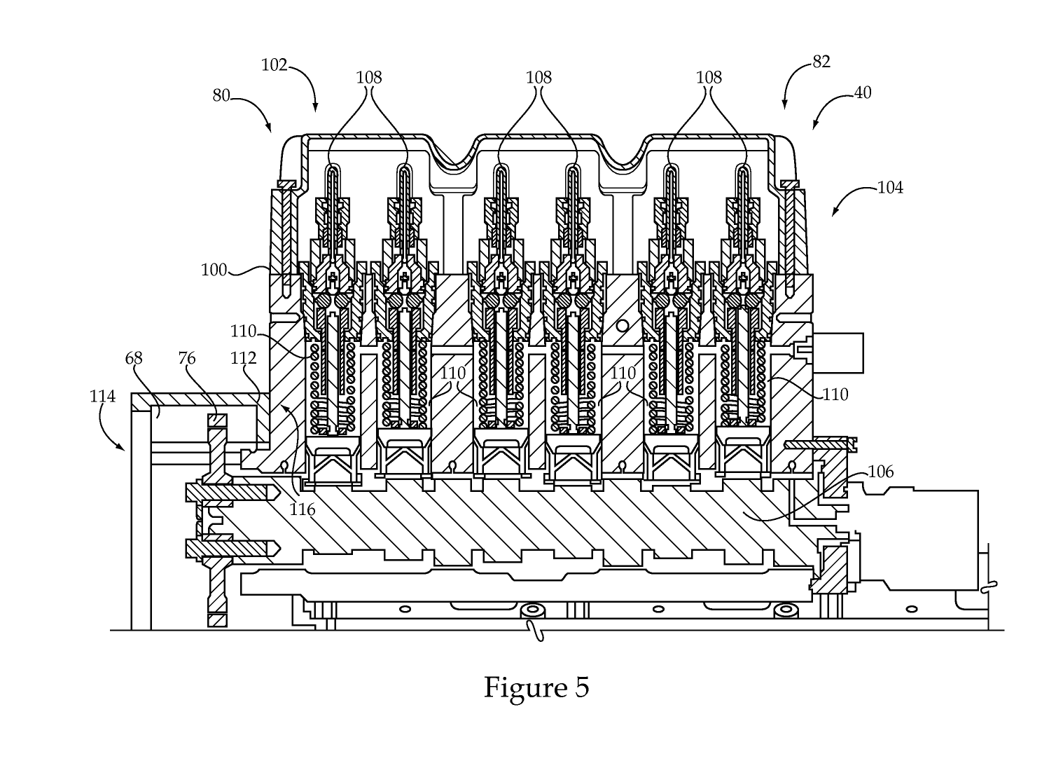

Turning now to FIG. 5, a cross sectional view of the high pressure fuel pump 40 is shown. The high pressure fuel pump 40 generally includes a fuel pump housing 100 having a first end 102 and a second end 104. A drive shaft 106 is positioned within the fuel pump housing 100 and extends from the first end 102 to the second end 104. A plurality of pistons 108 are configured to reciprocate within fluid chambers 110 upon rotation of the fuel pump drive shaft 106. The fuel pump drive shaft 106 is driven by the fuel pump gear 76, as described above. As shown, the fuel pump drive shaft 106 extends through a wall 112 of the flywheel housing 68 and is attached to the fuel pump gear 76 such that the fuel pump gear 76 is positioned on a first side 114 of the flywheel housing 68, or wall 112, and the fuel pump housing 100 is positioned on a second side 116 of the flywheel housing 68. As should be appreciated, the specific high pressure fuel pump 40 shown is provided for exemplary purposes only. Any fuel pump having any number of pistons arranged at angular distances sufficient to produce a desired pressure may be used.

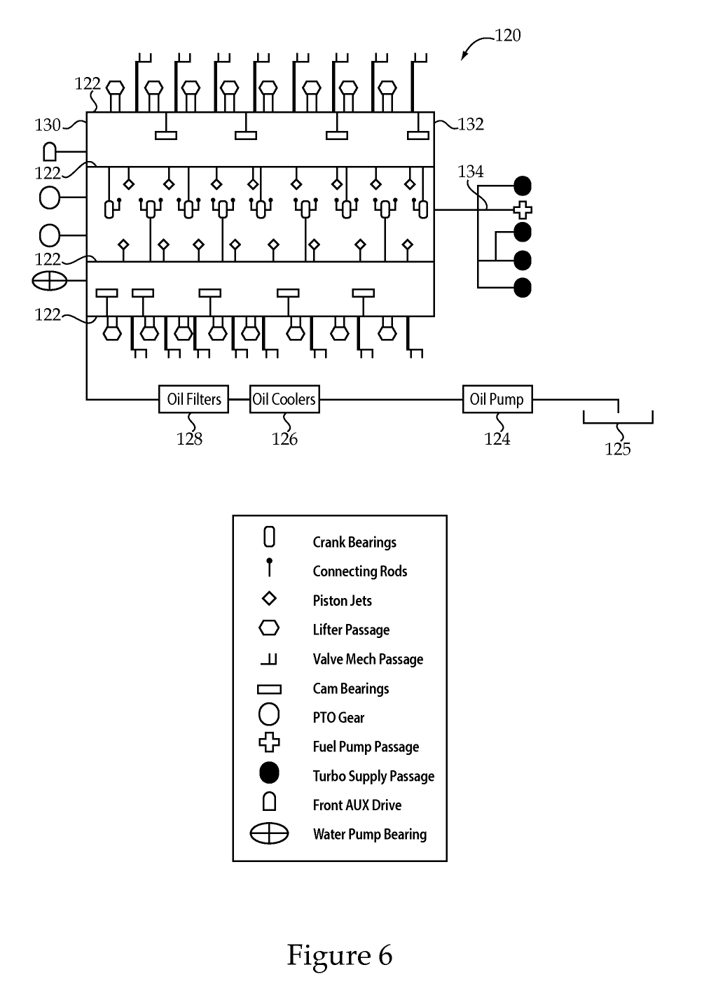

The engine system 10 also includes a lubrication system 120, a schematic of which is shown in FIG. 6. The lubrication system 120 may include a plurality of lubrication oil galleries 122, which may be defined by the engine block 14, arranged in parallel and receiving lubricating oil from an oil pump 124. Specifically, the oil pump 124 may draw oil from a sump 125, pressurize the oil, and circulate the pressurized oil first through an oil cooler 126 and one or more oil filters 128. The lubricating oil is then pumped along a first lubrication passage 130, from which lubricating oil is supplied to a number of engine components. Lubricating oil may also pass through the lubrication oil galleries 122, along which a number of additional engine components are supplied with lubricating oil, and to a second lubrication passage 132. From the second lubrication passage 132, lubricating oil is provided to a number of other engine components, including the high pressure fuel pump 40 along a pump lubrication pathway 134.

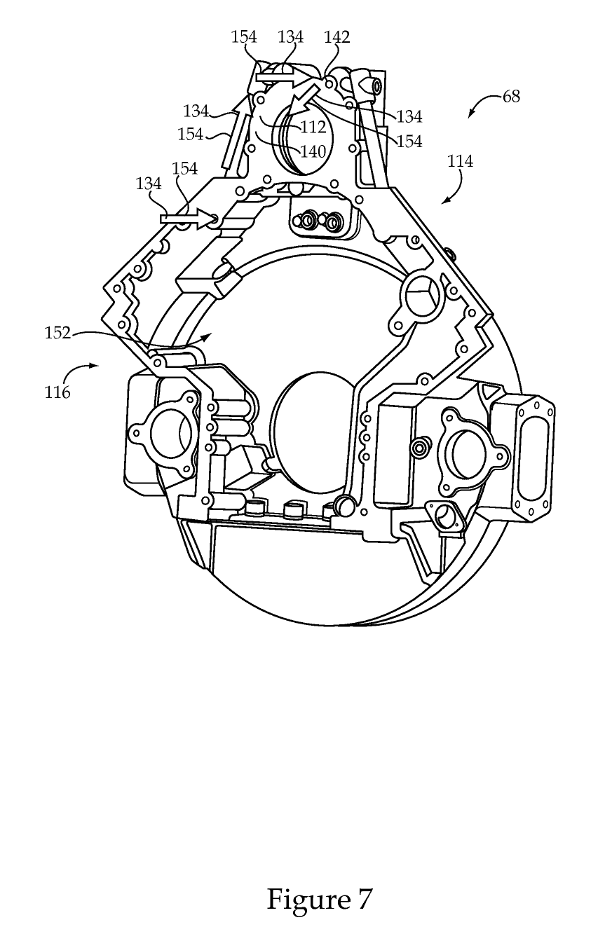

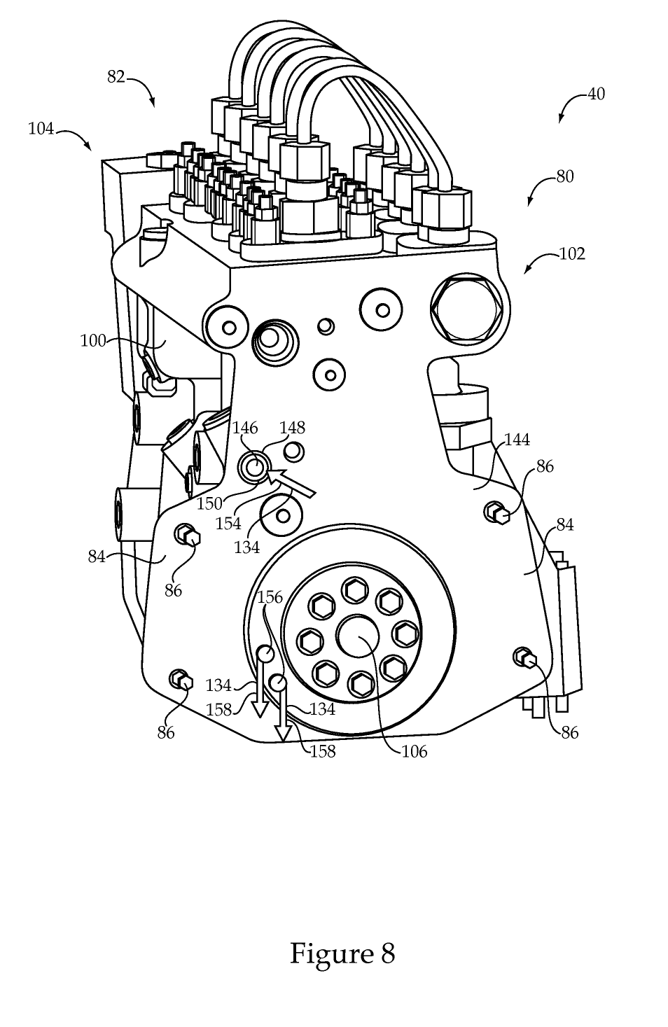

Turning now to FIGS. 7 and 8, a lubrication strategy of the present disclosure will be discussed in greater detail. Specifically, as shown in FIG. 7, the flywheel housing 68, shown facing the second side 116, includes a pump engagement face 140 having a first pump lubrication supply port 142 opening therethrough. Turning now to FIG. 8, the high pressure fuel pump 40 includes a planar face 144, or flywheel housing engagement face, defining at least a portion of the first end 102 of the fuel pump housing 100. The flywheel housing engagement face 144 has a second pump lubrication supply port 146 opening therethrough, and an annular groove 148 positioned about the pump lubrication supply port 146. As will be discussed later in greater detail, a sealing member 150 is positioned within the annular groove 148.

In an assembled state of the flywheel housing 68 and the high pressure fuel pump 40, the pump engagement face 140 of the flywheel housing 68 abuts the flywheel housing engagement face 144 of the high pressure fuel pump 40 such that the first pump lubrication supply port 142 and the second pump lubrication supply port 146 are in fluid communication. To supply lubricating oil to the high pressure fuel pump 40, lubricating oil may first be supplied to an interior 152 of the flywheel housing 68 from the second lubrication passage 132 (FIG. 6) along the pump lubrication pathway 134. The pump lubrication pathway 134 has an upstream segment 154 defined, at least in part, by the flywheel housing 68, the first pump lubrication supply port 142, and the second pump lubrication supply port 146. The pump lubrication pathway 134 is sealed against leakage between the pump engagement face 140 and the flywheel housing engagement face 144 at the pump lubrication pathway 134 using the sealing member 150.

The flywheel housing engagement face 144 of the high pressure fuel pump 40 also includes at least one pump lubrication drain port 156 opening therethrough. The pump lubrication pathway 134 further includes a downstream segment 158 defined, at least in part, by the pump lubrication drain port(s) 156 and the flywheel housing 68. Therefore, during operation of the internal combustion engine 12, lubricating oil is pumped along the upstream segment 154 of the pump lubrication pathway 134 and into the high pressure fuel pump 40, where moving components within the high pressure fuel pump 40 are lubricated in a known manner. The lubricating oil is then drained, along the downstream segment 158, from the high pressure fuel pump 40, through the interior 152 of the flywheel housing 68, and into the sump 125 using gravity.

### INDUSTRIAL APPLICABILITY

The present disclosure may be applicable to internal combustion engines having common rail fuel systems. Further, the present disclosure may be particularly applicable to positioning of the high pressure fuel pump relative to the engine block and the flywheel housing. Yet further, the present disclosure may be applicable to a lubrication strategy for the high pressure fuel pump. Specifically, lubricating oil may be shared between the flywheel housing and the high pressure fuel pump, which is at least partially supported on the flywheel housing.

Referring generally to FIGS. 1-8, an internal combustion engine 12 includes an engine block 14 defining a first row 60 and a second row 62 of cylinders 16. The rows 60 and 62 of cylinders 16 extend from a first end 64 of the engine block 14 toward a second end 66. A flywheel housing 68 is attached to the first end 64 of the engine block 14 and houses or supports a gear train 70. The gear train 70 may include a crank gear 72, which may be driven by a crankshaft 22, meshed to drive rotation of a cam gear 74. The power transmitted from the crank gear 72 to the cam gear 74 may be transferred to drive rotation of a fuel pump gear 76, which may drive a high pressure fuel pump 40.

The high pressure fuel pump 40 is mounted, or attached, to the flywheel housing 68 at a position over and above the engine block 14 and a V shaped area “A” defined by the first and second row of cylinders 60 and 62. According to the exemplary embodiment, the high pressure fuel pump 40 may have a first end 80 attached to the flywheel housing 68 and a second end 82 attached to the engine block 14 via a bracket 88. During operation of the internal combustion engine 12, the first end 80 of the high pressure fuel pump 40 is supported using the flywheel housing 68. Oscillation of the high pressure fuel pump 40 is reduced using the bracket 88, or other vibration transfer reduction member, positioned between the second end 82 of the high pressure fuel pump 40 and the engine block 14. Such positioning may provide improved accessibility to the high pressure fuel pump 40 and corresponding fuel lines.

Also during operation, lubricating oil is circulated through the engine block 14 per the lubrication system schematic of FIG. 6. This includes supplying lubricating oil to the high pressure fuel pump 40 along a pump lubrication pathway 134 having an upstream segment 154 defined, at least in part, by the flywheel housing 68, a first pump lubrication supply port 142, and a second pump lubrication supply port 146. The pump lubrication pathway 134 is sealed against leakage between a pump engagement face 140 of the flywheel housing 68 and a flywheel housing engagement face 144 of the high pressure fuel pump 40 at the pump lubrication pathway 134 using a sealing member 150.

Lubricating oil is drained from the high pressure fuel pump 40 through at least one pump lubrication drain port 156 opening through the flywheel housing engagement face 144. More specifically, the lubricating oil is drained from the pump lubrication drain port 156, through an interior 152 of the flywheel housing 68, and into a sump 125 using gravity.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. An internal combustion engine, including:
an engine block defining at least one row of cylinders, the row extending from a first end toward a second end;
a flywheel housing attached to the first end, the flywheel housing including a pump engagement face having a first pump lubrication supply port opening therethrough; and
a high pressure fuel pump including a flywheel housing engagement face having a second pump lubrication supply port opening therethrough;
wherein the pump engagement face of the flywheel housing abuts the flywheel housing engagement face of the high pressure fuel pump such that the first pump lubrication supply port and the second pump lubrication supply port are in fluid communication.

2. The internal combustion engine of claim 1, further including a pump lubrication pathway having an upstream segment defined, at least in part, by the flywheel housing, the first pump lubrication supply port, and the second pump lubrication supply port.

3. The internal combustion engine of claim 2, further including a sealing member positioned between the pump engagement face and the flywheel housing engagement face at the pump lubrication pathway.

4. The internal combustion engine of claim 2, wherein the flywheel engagement face of the high pressure fuel pump further includes a pump lubrication drain port opening therethrough, wherein the pump lubrication pathway further includes a downstream segment defined, at least in part, by the pump lubrication drain port and the flywheel housing.

5. The internal combustion engine of claim 1, wherein the high pressure fuel pump is positioned over and above the engine block.

6. The internal combustion engine of claim 1, wherein the engine block defines a first row of cylinders and a second row of cylinders, the first and second row of cylinders being arranged in a V configuration and defining a V shaped area, wherein the high pressure fuel pump is positioned over and above the V shaped area.

7. The internal combustion engine of claim 1, wherein the high pressure fuel pump is mounted to the flywheel housing.

8. The internal combustion engine of claim 7, wherein the high pressure fuel pump includes a drive shaft extending through a wall of the flywheel housing.

9. The internal combustion engine of claim 8, wherein a first end of the high pressure fuel pump is attached to the flywheel housing and a second end of the high pressure fuel pump is attached to the engine block.

10. The internal combustion engine of claim 8, further including a fuel pump gear attached to the drive shaft, the fuel pump gear being in mesh with a cam gear attached to a camshaft.

11. A method of operating an internal combustion engine, the internal combustion engine including an engine block defining at least one row of cylinders, the row extending from a first end toward a second end, a flywheel housing attached to the first end, the flywheel housing including a pump engagement face having a first pump lubrication supply port opening therethrough, and a high pressure fuel pump including a flywheel housing engagement face having a second pump lubrication supply port opening therethrough, wherein the pump engagement face of the flywheel housing abuts the flywheel housing engagement face of the high pressure fuel pump such that the first pump lubrication supply port and the second pump lubrication supply port are in fluid communication, the method including the steps of:
circulating lubricating oil through the engine block, wherein the circulating step includes supplying the lubricating oil to the high pressure fuel pump along a pump lubrication pathway having an upstream segment defined, at least in part, by the flywheel housing, the first pump lubrication supply port and the second pump lubrication supply port; and
sealing against leakage between the pump engagement face and the flywheel housing engagement face at the pump lubrication pathway using a sealing member.

12. The method of claim 11, further including draining lubricating oil from the high pressure fuel pump through a pump lubrication drain port opening through the flywheel housing engagement face.

13. The method of claim 12, wherein the draining step further includes draining the lubricating oil from the pump lubrication drain port, through an interior of the flywheel housing, and to a sump using gravity.

14. The method of claim 11, further including supporting a first end of the high pressure fuel pump using the flywheel housing.

15. The method of claim 14, further including reducing oscillation of the high pressure fuel pump using a vibration transfer reduction member positioned between a second end of the high pressure fuel pump and the engine block.

16. The method of claim 11, further including:
driving rotation of a fuel pump drive shaft using a fuel pump gear; and
driving rotation of the fuel pump gear using a cam gear attached to a camshaft.

17. The method of claim 16, further including driving rotation of the cam gear using a crank gear attached to a crankshaft.

18. A high pressure fuel pump for an internal combustion engine, including:
a fuel pump housing having a first end and a second end;
a drive shaft positioned within the fuel pump housing and extending from the first end to the second end;
a plurality of pistons, wherein each of the plurality of pistons is configured to reciprocate within a fluid chamber upon rotation of the fuel pump drive shaft; and
a planar face defining at least a portion of the first end of the fuel pump housing, the planar face having a pump lubrication supply port and a pump lubrication drain port opening therethrough;
wherein the planar face includes an annular groove positioned about the pump lubrication supply port.

19. The high pressure fuel pump of claim 18, further including a sealing member positioned within the annular groove.
